(19) United States
(12) Patent Application Publication
(10) Pub. No.: US 2002/0145040 A1
(43) Pub. Date: Oct. 10, 2002

(54) System and method for measuring cost of an item

(76) Inventor: John R. Grabski III, Branchport, NY (US)

Correspondence Address: CALFEE HALTER & GRISWOLD, LLP, 800 SUPERIOR AVENUE, SUITE 1400, CLEVELAND, OH, 44114, US

(21) Appl. No.: 10/054,086

(22) Filed: Jan. 22, 2002

Related U.S. Application Data
(60) Provisional application No. 60/263,632, filed on Jan. 23, 2001.

(51) Int. Cl. G06F 17/60

(52) U.S. Cl. 235/385

(57) ABSTRACT

A system and method are provided for determining the transaction cost of an item within a business. A cost processing system which may be a computer system or other device of like capability defines and/or allows a user to define departments within the business on the basis of differentiated cost-driving transactions that are required to process and/or handle a variety of items within the business. The cost processing system and method determine the transaction cost of an item to each department and the transaction cost of an item to the business based on the differentiating cost-driving transactions associated with the item.

### FIELD OF THE INVENTION

The present invention is directed to the computerized cost measurement arts.

### BACKGROUND

In order to facilitate business management, several existing software programs measure the cost of business processes. Prior art cost analysis tools include activity-based costing programs that capture the costs to manufacture a product or supply a service. These cost determinations allow a company to measure the profitability in supporting various customers that purchase the company's product or service.

These and other supply chain software programs which measure the cost to support customers are limited in their capacity to differentiate various transaction costs associated with each item and that collectively make up the costs to do business with individual suppliers. Business expenditures are typically allocated to an item without consideration being given to distinguishing activities that may affect the cost of a particular item.

In an increasingly competitive marketplace, suppliers have come up with ways to offer products with varying “value added” features that reduce the total cost of ownership for their customers. One example of a value added feature is bar coding on products which reduces the cost of handling components received from suppliers that offer bar-coded products. Another value added feature is “electronic funds transfer” (EFT) which reduces the cost of issuing invoices for accounts payable.

Prior art systems that measure costs associated with specific customers do not account for supplier-related costs. That is, these systems do not provide the tools to analyze the difference between the cost of an item with one or more value-added supply features from the costs of an item that is supplied without a value-added feature. For example, traditional systems are not capable of differentiating between the cost of an item that is supplied with a bar code and the cost of an item that is received without a bar code.

### SUMMARY

In one embodiment, the present invention provides for a cost processing system that more accurately determines the transaction costs associated with an item that is obtained by a business. The cost processing system comprises input logic that defines the departments that process the item. The input logic also defines the portion of business expenditures attributable to each department so that the expenditures can be automatically distributed to each department. The cost processing system optionally comprises import logic that imports the number of each item processed by the business and imports the various business expenditures. The imported data can be retrieved, for example, from the business operations system and can be stored on the memory or can be accessed by the cost processing system. The cost logic then uses the imported data and the allocation of business expenditures to calculate the transaction cost of each item to each department, and the transaction cost of an item to the business.

In another embodiment, a method for measuring the transaction costs of an item is provided. The method comprises defining the departments that generate distinguishable cost-driving activities or transactions associated with the item, and defining the portion of expenditures attributable to each department. The method further comprises obtaining the business expenditures- incurred and obtaining the number of items processed within each department to determine the cost of the item in each department.

In another embodiment, a program embodied in a computer-readable medium for determining the total cost of ownership of an acquired item is provided. The program includes computer-executable instructions that cause a computer to operate in the described manner.

Other features and advantages of the present invention will become apparent to a person with ordinary skill in the art in view of the following drawings and detailed description. It is intended that all such additional features and advantages be included herein within the scope of the present invention.

### DESCRIPTION OF THE DRAWINGS

In the accompanying drawings which are incorporated in and constitute a part of the specification, embodiments of the present invention are illustrated, which together with a general description of the invention given above and the detailed description below, serve to explain the principles of this invention.

FIG. 1 is an exemplary system diagram that includes a cost processing system according to one embodiment of the present invention; and

FIG. 2 is a block diagram showing an exemplary methodology of cost processing in accordance with one embodiment of the present invention.

### DETAILED DESCRIPTION

The following includes definitions of exemplary terms used throughout the disclosure. Both singular and plural forms of all terms fall within each meaning:

“Software,” as used herein, includes, but it not limited to, one or more computer readable and/or executable instructions, routines, algorithms, modules or programs including separate applications or ones from dynamically linked libraries for performing functions, acts and events as described herein. Software may also be implemented in various forms such as a servlet, an applet, a stand-alone program including a server based application and a user based application, a plug-in or other type of application.

“Logic,” as used herein, includes, but is not limited to, hardware, software and/or combinations of both to perform one or more functions, acts and/or events.

“Network,” as used herein, includes, but is not limited to, the Internet, Intranets, Wide Area Networks (WANs), Local Area Networks (LANs), and transducer links such as those using Modulator-Demodulators (modems).

“Internet,” as used herein, includes a wide area data communications network, typically accessible by any user having appropriate software.

“Intranet,” as used herein, includes a data communications network similar to an Internet, but typically having access restricted to a specific group of individuals, organizations, or computers.

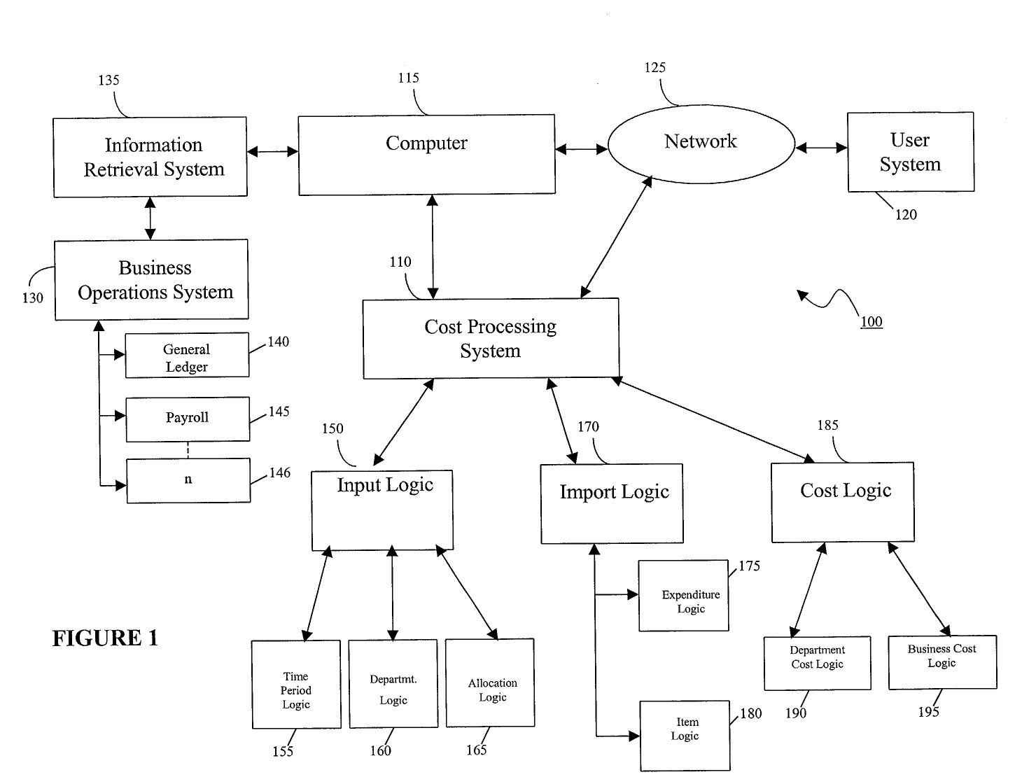

With reference to FIG. 1, shown is an exemplary system diagram 100 in accordance with one embodiment of the present invention. The system diagram 100 includes cost processing system 110 that determines transaction costs of each item that a business transacts, for example, when it obtains the item from a supplier.

As an overview, in one embodiment cost processing system 110 measures the transaction costs of an item based on cost-driving transactions or activities as an item is transacted in various ways throughout a business, for example, transactions in the material movement process. In another embodiment the cost processing system measures the impact of supplier value-added services on the cost-driving transactions or activities that pertain to the item, for example, throughout the material movement process.

As an example of how transaction costs can vary among items that are supplied with different value-added features, consider a company that is making a decision to buy pencils from one of two different suppliers. If supplier A offers pencils for $0.10 each and supplier B offers pencils for $0.08 each, then under ordinary cost analyses, the company would choose to buy from the supplier B which offers a lower price. However, if supplier A supplies the pencils with bar-coded packaging, the cost of processing a box of pencils in the receiving department may take 15 seconds and cost about $0.25 in labor, whereas the cost of processing a box of pencils without bar-coded packaging from supplier B may take two minutes and cost about $2 in labor.

The cost processing system 110 according to one embodiment can determine whether the transaction costs of pertaining to a pencil from supplier A is less than the transaction costs associated with a pencil from supplier B. The difference between the transaction costs to process a pencil in the two receiving departments may alone be great enough to choose supplier A over supplier B even though supplier B offers a lower price. The cost processing system allows a company to distinguish the costs of items from different sources of supply and which involve different cost-driving activities and/or transactions throughout the business. The various cost-driving transactions which are specific only to certain items and unrelated to other items can be compartmentalized into different departments in order to separate the transaction costs pertaining to the different items.

In one embodiment of the present invention, a computer 115 receives requests for the cost of an item from one or more user systems 120 connected thereto via a network 125 or by direct connection. The cost processing system 110 can be, for example, a server, client or other network element that is coupled to network 125. The cost processing system 110 may also comprise software or code embodied in any computer-readable medium. In this sense, the code comprises, for example, instructions that are read from the computer-readable medium and executed by computer 115. In the context of this document, a “computer-readable medium” is any medium that contains computer readable information. The computer-readable medium, for example, includes electronic, magnetic, optical electromagnetic, infrared, or semiconductor media. More specific examples include, but are not limited to, a portable magnetic computer diskette such as floppy diskettes or hard drives, a random access memory (RAM), a read-only memory (ROM), an erasable programmable read-only memory, or a portable compact disk.

Generally, the computer 115 may take many forms from a configuration including a variety of processing units networked together to function as an integral entity, to a single computer, e.g. a personal computer, operational in a stand-alone environment. The present invention can be embodied in any of these computer system configurations.

The computer 115 executes the cost processing system 110 which may call on a business operations system 130, a component within an information retrieval engine 135, to retrieve business information that is used to operate and manage a business. Business information, namely, the purchased items and business expenditure data are typically found in the business operations system in the format of a general ledger 140, however, more detailed reports of expenditures, such as payroll reports 145 or a number of other “n” reports 146, for example, are also usually available within the business operations system 130. Alternatively, the business operations system 130 may be received, for example, through the network 125.

The cost processing system 110 comprises input logic 150, import logic 170 and cost logic 185. As will be described in more detail below, the input logic may have one or more components such as logic to define departments within the business from which cost-driving activities or transactions are generated, logic by which business expenditures are allocated to the departments, and logic to determine the time period for cost evaluation. The import logic obtains the business expenditures and the number of items that are processed by the defined departments so that the cost logic can determine the transaction cost associated with an item in each department and in the business.

In one embodiment of the invention, the input logic 150 comprises time period logic 155 that defines and/or allows a user to define a time period, for example, a week, a month, quarter, year, or any desired period, for which the total cost of ownership of a line item is determined. By analyzing a series of time periods, the user can keep track of period-to-period changes in the transaction costs of an item. The user can also determine short and long period trends in these costs. The time period logic 155 receives input for the date that the period will begin, or if no date is entered, the default value can be “today's date”. The date range is then calculated automatically based on the defined time period.

In another embodiment, the input logic 150 comprises department logic 160 that defines and/or allows a user to define departments within the business based on differentiating cost-driving activities or transactions that are associated with some items but not others. A cost-driving activity or transaction can be any one or more activities related to processing or handling a line item that uses company resources. For example, in the receiving department, the activity of unloading a shipment of pencils from a supplier's truck is a cost-driving activity. For example, the cost of unloading and receiving a shipment can include labor and the capital cost of equipment such as bar-code scanners, computers and tow motors and/or other equipment used in the activity. The department logic 160 allows creation of any department in order to distinguish the cost-driving transactions associated with one item from the cost-driving activities associated with another item.

As an example of how the cost processing system distinguishes cost-driving transactions associated with certain items, input logic may define two receiving departments, a bar-code receiving department and a traditional non-bar-code receiving department. In this manner, the expenditures that are associated with processing the items having a bar code can be allocated separately from the expenditures associated with the items without a bar code. The difference in the cost of processing bar-coded versus non-bar-coded items can be readily seen in the labor expenditures made by two different departments. Labor expenditures in the bar-code receiving department may tend to be less than the labor expenditures in the traditional receiving department where line item information must be recorded or put into a computer system manually. By creating two receiving departments, the transaction cost of processing an item that is bar-coded can be determined separately from the transaction cost of processing an item that is not bar-coded. This ultimately impacts the cost of each item incurred by the business as determined by the cost logic 185 described below.

As another example, an “electronic funds transfer” (EFT) accounts payable department which is distinct from a “check-cashing” accounts payable department may be created to track the costs of ownership of line items from suppliers offering different forms of payment. The expenditures in processing invoices in the EFT accounts payable department is less than the expenditures in the check-cashing department if less labor, paper, or other material costs are incurred. The creation of additional departments based on distinguishable cost-driving transactions leads to a more accurate determination of the incremental costs of processing an acquired item and a more accurate determination of the transaction costs of an item.

The input logic 150 further comprises allocation logic 165 that determines the manner in which the business expenditures are allocated 165 to the various defined departments. The term “business expenditures” refers to expenses, investments and/or any utilization of resources that a business makes in its day to day operation. For example, business expenditures can be one or more of a monetary short-term and long-term expense. Business expenditures are often categorized under named business accounts such as, for example, office supplies, computer equipment, depreciation, payroll, tow motor vehicles, utilities, property tax, etc., to name just a few.

The import logic 170 comprises expenditure logic 175 that accepts, retrieves and/or otherwise obtains the business expenditures in each business account. As mentioned above, the business expenditure data can be found in the business operations system 130 stored on the hard drive or accessed through the network 125 and/or the information retrieval system 135, for example. The business expenditures can also be entered by the user. The method or format by which business expenditures are stored in data files and/or is inputted, generally depends upon the type of business.

Table 1 represents an example of the way by which business expenditures can be allocated to the defined departments. A distribution business, for example, may have the following defined departments: purchasing, bar-code receiving, non-bar-code or manual receiving, quality control (QC), kitting, electronic-funds-transfer accounts payable (EFT A/P), manual accounts payable, and administration. The period expenditures of only a few of several possible business accounts are listed on Table 1. For example, period expenditures are $250 for office supplies, $2000 for computer equipment, $17,000 for payroll and so on.

In one embodiment of the invention, allocation logic 165 assigns portions of business expenditures to the various departments based on a percentage of the account expenditures. The top row pertaining to each business account shows, for example, that the portion of payroll expenditures assigned to purchasing is 5%, the portion assigned to the bar-code receiving department is 5%, and the portion assigned to the non-bar-code, manual receiving department is 20%, and so on.

The basis for allocating 5% and 20% of payroll expenditures to the bar-code receiving and manual receiving departments, respectively, can be, for example, the number of employees, their respective wages, and/or the number of hours worked. As another example, business expenditures such as office supplies can be allocated evenly to each employee. In such case the proportion of office supplies is based simply on the number of individuals that work in each department.

TABLE 1

| 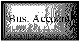 | 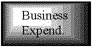 | 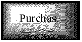 | 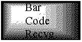 | 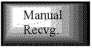 | 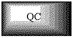 | 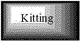 | 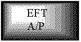 | 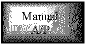 | 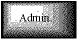 |
|---|---|---|---|---|---|---|---|---|---|
| 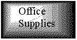 | $250 | 20% | 3% | 8% | 15% | 5% | 3% | 6% | 40% |
| 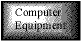 | $2000 | 10% | 10% | 0% | 20% | 0% | 10% | 0% | 50% |
| 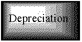 | $200 | 5% | 25% | 0% | 10% | 0% | 10% | 0% | 50% |
| 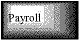 | $17,000 | 5% | 5% | 20% | 5% | 30% | 5% | 20% | 10% |
| 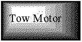 | $1,500 | 0% | 20% | 30% | 0% | 50% | 0% | 0% | 0% |
| 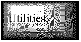 | $3,000 | 5% | 10% | 15% | 15% | 25% | 5% | 5% | 20% |
| 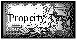 | $2,000 | 5% | 10% | 15% | 15% | 25% | 5% | 5% | 20% |

In another embodiment, allocation logic 165 assigns portions of business expenditures to the various departments based on the relative sizes of the departments. For example, in many companies some business account expenditures, such as utilities or property taxes which are fixed costs, are budgeted according to the physical size or area of a department. In such case, the allocation logic 165 assigns the utilities and/or property tax expenditures according to the relative size of the department rather than the variables mentioned above. The department logic 160 defines the space requirements of each of the departments, and the allocation logic 165 determines the portion of business expenditures based on the fraction of the total space consumed by each department. In Table 1, the allocation of the utilities expenditures of 5% in purchasing, 10% in bar code receiving, and 15% in manual receiving, for example, may correspond to the relative department sizes.

In yet another embodiment, the allocation logic 165 can assign a fixed monetary amount of business expenditures to each of the departments. For example, the percentage of the expenditures, based on department size or other factors such as discussed above, are not the basis of allocating expenditures. Rather the allocation logic can assign, for example, any monetary amount for expenditures in each of the departments.

The allocation logic 165 can allow a user to input and define expenditure allocations, for example, via a dialog box. A dialog box can accept a check mark or other notation if the business expenditures are to be allocated as a function of department size. The allocation logic 165 can also allow for changes to the allocation of business expenditures to each of the departments from one time period to another or even within the same time period of evaluation. The impact of such changes can be made by comparing the resulting transaction costs of an item.

Cost logic 185 calculates the portion of business expenditures attributable to each department. The calculation is based on the business expenditures obtained by the expenditure logic 175 and allocations defined by the allocation logic 165. Table 2 shows the same example data in Table 1 with the addition of the calculated dollar amount of business expenditures in each department. For example, the bottom row corresponding to the utilities business account shows that $150, which is 5% of $3,000, is allocated to the purchasing department, $300 which is 10% of $3,000 to the bar-code receiving department and $450 which is 15% of $3000, to the manual receiving department. Cost logic 185 therefore determines the transaction cost to each department for processing and/or handling various items over a period of time.

TABLE 2

| 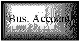 | 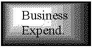 | 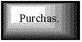 | 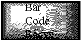 | 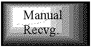 | 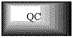 | 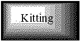 | 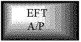 | 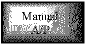 | 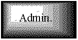 |
|---|---|---|---|---|---|---|---|---|---|
| 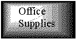 | $250 | 20% $50 | 3% $7.50 | 8% $20 | 15% $37.50 | 5% 12.50 | 3% $7.50 | 6% $15 | 40% $100 |
| 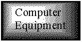 | $2000 | 10% $200 | 10% $200 | 0% $0 | 20% $400 | 0% $0 | 10% $200 | 0% $0 | 50% $1,000 |
| 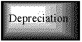 | $200 | 5% $10 | 25% $50 | 0% $0 | 10% $20 | 0% $0 | 10% $20 | 0% $0 | 50% $100 |
| 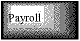 | $17,000 | 5% $850 | 5% $850 | 20% $3,400 | 5% $850 | 30% $5,100 | 5% $850 | 20% $3,400 | 10% $1,700 |
| 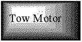 | $1,500 | 0% $0 | 20% $300 | 30% $450 | 0% $0 | 50% $750 | 0% $0 | 0% $0 | 0% $0 |
| 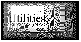 | $3,000 | 5% $150 | 10% $300 | 15% $450 | 15% $450 | 25% $750 | 5% $150 | 5% $150 | 20% $600 |
| 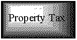 | $2,000 | 5% $100 | 10% $200 | 15% $300 | 15% $300 | 25% $500 | 5% $100 | 5% $100 | 20% $400 |

In another embodiment, cost logic 185 further comprises department cost logic 190 which determines the transaction cost of a single item in each department. The transaction cost of an item in each department is determined from the transaction costs incurred and the number of items processed or handled in each department for a time period. That is, the item logic 180 accepts, retrieves and/or obtains data pertaining to the number of items processed or handled by each department, and is used to determine transaction costs on a per item basis. Data pertaining to the quantity and/or identity of and item can be entered by the user or can be imported from the business operations system 130. For example, the transaction cost of an item in each department can be calculated by summing the expenditures that were allocated to each department and dividing by the number of items processed in each department. In such case, the result is an average transaction cost of an item in each department.

The transaction cost of an item in each department can vary from department to department as a result of different cost-driving activities associated with each department. Table 3 shows exemplary business expenditures and the number of items processed in each of the departments, and the resulting transaction cost of an item in each department.

TABLE 3

| 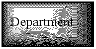 | 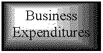 | 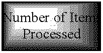 | 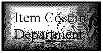 |
|---|---|---|---|
| 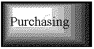 | $9,950 | 2,433 | $4.09 |
| 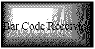 | 3,096 | 996 | 3.11 |
| 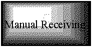 | 7,250 | 1,732 | 4.19 |
| 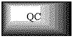 | 4,635 | 428 | 10.83 |
| 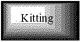 | 5,448 | 635 | 8.58 |
| 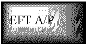 | 1,362 | 1,372 | .99 |
| 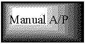 | 2,897 | 1,459 | 1.98 |
| 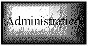 | 14,242 | 250 | 56.97 |

In another embodiment, the cost logic 185 further comprises business cost logic 195 which calculates the transaction cost of an item to the business. The transaction cost of an item to a business may be determined, for example, by summing the transaction cost of an item in each and every department that processes and/or handles the item. For example, if a pencil A from supplier A is associated with eight of the ten departments listed in Table 3, then business cost logic 195 can sum the transaction cost of pencil A in the eight departments that process and/or handle the pencil to arrive at the transaction cost to the business for pencil A from supplier A.

The transaction costs of an item are useful for comparing costs associated with two different items or the same type of item supplied by two different companies. For example, the transaction cost of pencil A in a department and/or a business can be compared to the transaction cost of pencil B from supplier B. Suppose supplier B does not bar code its pencils and does not handle invoicing through electronic funds transfer (EFT). The transaction cost of pencil B from supplier B in the manual accounts payable (A/P) department is $1.98 per box of pencils and the transaction cost of pencil B in the manual receiving department is $4.19 per box of pencils. By comparison, the transaction cost of pencil A from supplier A in the EFT accounts payable department is $0.99 per box of pencils and the transaction cost of pencil A in the bar code receiving department is $3.11 per box of pencils. If both pencils are processed and/or handled in all the same departments listed in Table 3, except for the receiving and accounts payable departments, then transaction cost to the business is greater for pencil B from supplier B than pencil A from supplier A.

The present invention enables a business to quantify the impact of value-added supply features. The transaction cost of an item, in addition to the purchase price, may be used to evaluate various suppliers offering different supply packages. This information can also be used for quoting a product, using any number of items, to customers or potential customers. The system can allow a business to also determine which departments, and therefore, which cost-driving activities may cause the item to be particularly economical or costly. It can be determined which of a company's suppliers and/or customers are profitable business partners. The cost processing system can allow several different analyses to be made by changing, for example, the defined departments and/or the defined expenditure allocations to determine the effects of such changes. The system can be executed repeatedly to view the effects of various recommendations and scenarios.

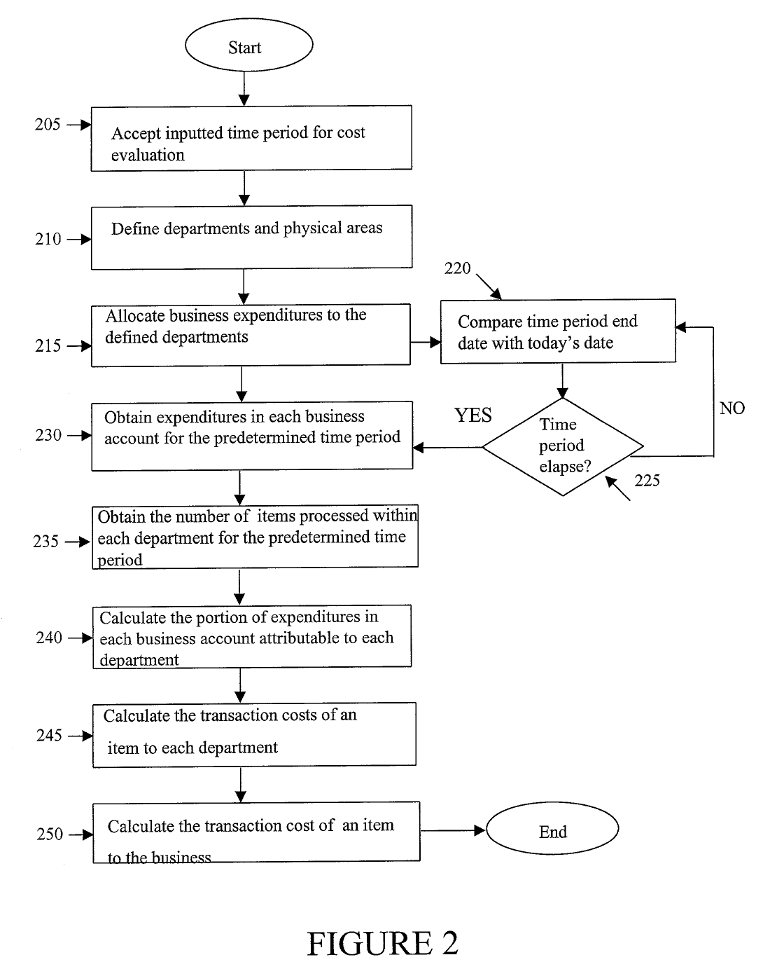

FIG. 2 shows an exemplary methodology to determine the transaction cost of an item in accordance with one embodiment of the present invention. The blocks shown represent functions, actions or events performed therein. If embodied in software, each block may represent a module, segment or portion of code that comprises one or more executable instructions to implement the specified logical function(s). If embodied in hardware, each block may represent one or more circuits or other electronic devices to implement the specified logical function(s). It will be appreciated that computer software applications involve dynamic and flexible processes such that the functions, actions or events performed by the software and/or the hardware can be performed in other sequences different than the one shown.

Cost processing system 110 provides input logic that defines or allows a user to optionally define the time period for cost evaluation (box 205). The input logic also allows a user to define the departments within the company that generate cost-driving activities or transactions in processing or handling acquired items (box 210). The departments can be distinguished and defined according to specific cost-driving activities and/or transactions to which business expenditures can be assigned. In addition, the input logic can define or allows a user to define the space requirement of each department, such as, for example, the physical area. The size of the department can serve as a basis for allocating business expenditures to the various departments. The input logic can also define the allocation of business expenditures to the defined departments within the company (box 215).

The input logic can compare the time period ending date to the current date (box 220) and determine whether the current date is at least as great as the ending date entered for the period of evaluation (box 225). If the time period has not yet elapsed, then the input logic compares the time period each day until the inputted time period has elapsed. When the defined time period for evaluation has elapsed, information stored on business operations system 130 (FIG. 1) is manually obtained or automatically imported (box 230). The business operations system comprises data files of the company's business expenditures in the form of financial statements, for example, the general ledger, as well as information pertaining to the individual items that are purchased by the business. The import logic obtains the total number of items processed or handled within each department (box 235).

The cost logic calculates and distributes the business account expenditures to each applicable department for the selected time period (box 240) based on the defined allocation of business expenditures (box 215). The cost logic then calculates the transaction cost of an item in each department based on the business expenditures allocated to each department and the number of items processed and/or handled in each respective department (box 245). The transaction cost in each department can be used to calculate the cost of an item to the business (box 250).

Although the flow chart of FIG. 2 shows an exemplary order of execution, it is understood that the order of execution may differ from that which is depicted. Also, two or more blocks shown in FIG. 2 may be combined and/or executed concurrently or with partial concurrence. It is understood that all such variations are within the scope of the present invention. Also, the flow chart of FIG. 2 is understood by those with ordinary skill in the art to the extent that software and/or hardware can be created to carry out the various logical functions as described herein.

Although the invention is shown and described with respect to certain preferred embodiments, it is obvious that equivalents and modifications will occur to others skilled in the art upon the reading and understanding of the specification. The present invention includes all such equivalents and modifications and is limited only by the scope of the claims.

What is claimed is:

1. A cost processing system for determining a transaction cost of an item, the system comprising:
department logic to define one or more departments which produce cost-driving transactions;
allocation logic to define an allocation of business expenditures attributable to each defined department;
item logic to obtain a number of items transacted in each department; and
cost logic to determine transaction costs of each of the items in each of the defined departments based on the allocation of business expenditures to each of the defined departments and the number of items transacted in each of the defined departments.

2. The cost processing system of claim 1 further comprising time period logic to define a time period for determining the transaction costs of each of the items.

3. The cost processing system of claim 2 further comprising an interface for a user to define a time period for evaluation, define one or more departments, and define the allocation of the one or more business expenditures to each department.

4. The cost processing system of claim 1 further comprising expenditure logic to obtain one or more of the business expenditures.

5. The cost processing system of claim 1 wherein the department logic comprises logic for defining a physical space measurement associated with each of the one or more departments.

6. The cost processing system of claim 1 wherein the allocation logic comprises logic to define the allocation of business expenditures to each of the departments based on at least one of a predetermined monetary amount and a proportion of the business expenditures.

7. The cost processing system of claim 1 wherein the allocation logic comprises logic to define the allocation of business expenditures to each of the departments based on at least one of a physical space measurement of each department, a predetermined monetary amount, and a proportion of the business expenditures.

8. The cost processing system of claim 1 wherein the cost logic to determine the transaction cost of an item comprises:
logic to sum, for each department, the business expenditures allocated to each department; and
logic to divide the sum for each department by the number of items transacted in each of the respective departments to obtain the transaction cost of an item to each department.

9. The cost processing system of claim 8 wherein the cost logic further comprises
logic to sum the transaction cost of an item in each department for each department that transacts the item, to obtain the transaction cost of an item to the business.

10. The system of claim 1 wherein the system is embodied as a computer software product having computer-readable instructions.

11. A cost processing system for determining a transaction cost of an item, the system comprising:
means for defining one or more departments which produce cost-driving transactions;
means for defining an allocation of business expenditures attributable to each defined department; and
means for determining the transaction costs of each of the items in each of the defined departments based on a number of items transacted in each of the defined departments the defined allocation of business expenditures to each of the defined departments and.

12. A method for determining a transaction cost of an item, the method comprising:
defining one or more departments which produce cost-driving transactions;
allocating business expenditures to the defined departments;
obtaining the number of items processed in each defined department; and
determining a transaction cost of an item in each department based on the allocation of business expenditures to each department and the number of items processed in each defined department.

13. The method of claim 12 further comprising:
defining a time period of cost evaluation.

14. The method of claim 13 further comprising:
obtaining business expenditures in the time period for cost evaluation.

15. The method of claim 12 wherein the allocation of business expenditures to each of the defined departments is based on at least one of a predetermined monetary amount, and a proportion of the business expenditures.

16. The method of claim 12 further comprising:
defining a physical space measurement for each of the one or more defined departments; and
wherein the allocation of business expenditures to each of the defined departments is based on at least one of a defined space requirement of each department, a monetary amount, and a proportion of the business expenditures.

17. The method of claim 12 wherein the transaction cost of an item is determined by:
summing, for each department, the business expenditures allocated to each department to obtain a sum; and
dividing the sum by the number of items transacted in each of the respective departments to obtain the transaction cost of an item to each department.

18. The method of claim 17 further comprising:
summing the transaction cost of an item to each department that transacts the item to obtain the transaction cost of an item to the business.

19. A computer program stored in a computer-readable medium for determining transaction costs of an item, the complete program comprising:
computer-readable instructions that cause a computer to define one or more departments which produce cost-driving transactions;
computer-readable instructions that cause a computer to allocate business expenditures attributable to each defined department; and
computer-readable instructions that cause a computer to determine the transaction costs of each of the items in each of the defined departments based on a number of items transacted in each of the defined departments and the defined allocation of business expenditures to each of the defined departments.
